(19) United States
(12) Patent Application Publication
(10) Pub. No.: US 2002/0033971 A1
(43) Pub. Date: Mar. 21, 2002

(54) Image input device

(76) Inventors: Kosuke Takaki, Kasuga-shi (JP); Takeyasu Saito, Onojo-shi (JP)

Correspondence Address: STEVENS, DAVIS, MILLER & MOSHER, L.L.P., Suite 850, 1615 L Street, N.W., Washington, DC, 20036, US

(21) Appl. No.: 09/946,522

(22) Filed: Sep. 6, 2001

(30) Foreign Application Priority Data
Sep. 8, 2000 (JP) 2000-272825

(51) Int. Cl. H04N 1/40

(52) U.S. Cl. 358/448

(57) ABSTRACT

An image input device for converting input of a high resolution multivalue image data to transmit high-resolution binary image data and low-resolution multivalue image data without reducing transmission speed. Image data from a manuscript read in by a CCD is converted into digital multivalue image data by an A/D conversion portion, the multivalue image data thus obtained is binarized by binarization portion and stored in a first storage portion. The resolution of the multivalue image data is lowered by a resolution conversion portion, the gradation value is converted by a multivalue processing portion and the data is stored in a second storage portion. A first image data stored in the first storage portion and a second image data stored in the second storage portion are each output through an interface portion to a PC.

### BACKGROUND OF THE INVENTION

This invention relates to an image input device for reading in an image from a manuscript and transferring the image to another device.

An image input device such as an image scanner reads in a variety of images like a picture, photograph or document and transmits the image data read-in to another device such as a computer. An image scanner basically provides a line image sensor in the form of a photoelectric transducer such as a CCD arranged in rows in the main scanning direction that reads one line of an image at a time by scanning, sequentially stores the data in memory and transmits the data to a computer.

A conventional image scanner outputs image data read-in by a CCD in either a multivalue color, multivalue black-and-white or binary black-and-white data format. Accordingly, when both binary image data and either color multivalue or black-and-white multivalue image data is required, multivalue image data is output from the image scanner side and a method is employed in which the output data is converted into binary image data in the computer which receives the output.

Ordinarily, the time expended in transmitting read-in image data from an interface to a computer is longer than the time expended by an image scanner reading in an image from one page. Accordingly, multivalue image data, which has a high volume of data, requires a longtime for transmission and so the read-in speed of the image scanner is slowed down resulting in a reduced read-in speed by the image scanner.

Especially when obtaining binary image data for OCR from image data conversion by computer, it is necessary to have high-resolution multivalue image data of at least 300 dpi or more. That is an extremely high volume of data which leads to an extremely long time required for transmission. The storage function is the main flow for the handling of multivalue image data and because even multivalue image data at a low-resolution of 200 dpi or less is sufficient, substantial loss is incurred in converting high-resolution multivalue image data.

### SUMMARY OF THE INVENTION

The present invention provides an image input device which makes it possible, without reducing transmission speed, to obtain high-resolution binary image data and low-resolution multivalue image data.

An image input device of the present invention is constructed so that in addition to changing input multivalue image data into binary data, the resolution of multivalue image data is lowered, and both binary image data and multivalue image data of a lowered resolution are each output.

In this way both high-resolution binary image data and low-resolution multivalue image data are obtained from the original input multivalue image data, and the volume of data in the combination of the high-resolution binary image data and low-resolution multivalue image data is made less than that of the high-resolution multivalue image data originally read-in, thereby preventing deterioration in transmission speed.

According to a first aspect of the invention, an image input device comprises means for binarization for changing input black-and-white multivalue image data into binary data, means for temporary storage of a first image data changed into binary data by the binarization means, means for converting resolution for lowering the resolution of multivalue image data, means for temporary storage of a second image data with resolution lowered by the resolution converting means, and means for outputting the stored first image data and the stored second image data, so that both high-resolution binary image data and low-resolution multivalue image data are obtained from the original input multivalue image data.

According to a second aspect of the invention, an image input device according to the first aspect further includes means for converting data to black-and-white for converting color multivalue image data into black-and-white multivalue image data, wherein the binarization means is a means for converting black-and-white multivalue image data into black-and-white binary image data, and the resolution converting means is a means for lowering the resolution of color multivalue image data or of black-and-white multivalue image data, so that both high-resolution black-and-white binary image data and either low-resolution color multivalue or low-resolution black-and-white multivalue image data are obtained from the original, input color multivalue image data.

According to a third aspect of the invention, an image input device according to either the first aspect or the second aspect of the invention is adapted such that the resolution converting means converts the resolution of multivalue image data to that lowered by an n th power of ½ with an integer “n”, so that the resolution is lowered by a simple process of thinning out or skipping read-in data lines.

According to a fourth aspect of the invention, an image input device according to any one of the first through third aspects of the invention is adapted such that the output means outputs alternately for each line read-in or each page read-in the stored first image data and the stored second image data, so that multivalue data and binary data can be obtained alternately for each line of data read-in (in other words for each line in the main scanning direction) or for each page read-in.

### BRIEF DESCRIPTION OF THE DRAWINGS

FIG. 1 is a block diagram illustrating an arrangement of an image scanner image input device according to an embodiment of the present invention.

FIG. 2 is a block diagram of another example of a modified connection circuit to be used instead of the corresponding circuit in the arrangement of FIG. 1.

FIG. 3 is a block diagram of still another example of a circuit to be used instead of the corresponding circuit in the modified circuit of FIG. 2.

### DESCRIPTION OF THE EMBODIMENTS

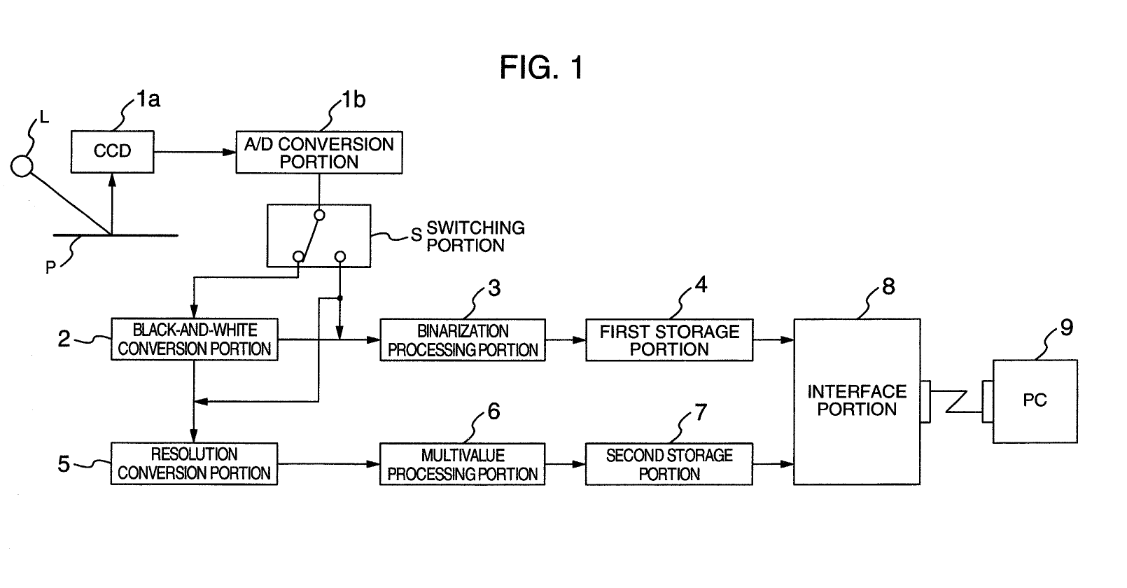

Referring to FIG. 1, an image scanner according to a preferred embodiment of the present invention includes a CCD image sensor (hereinafter “CCD”) 1a for reading in an image from a manuscript P illuminated by a light source L, A/D conversion means or portion 1b for converting analog data read-in by CCD 1a into digital multivalue image data, a black-and-white conversion portion 2 for converting multivalue image data into black-and-white multivalue image data, binarization processing portion 3 for binary processing of multivalue image data and first storage portion 4 for backup temporary storage of a first image data processed into binary data by the binarization processing portion 3. Herein the word “portion” is also used to represent such as means, device, unit, etc.

The image scanner also provides a resolution conversion portion 5 for lowering the resolution of multivalue image data, a multivalue processing portion 6 for converting the gradient or gradation value of multivalue image data, a second storage portion 7 for backup temporary storage of a second image data processed by the multivalue processing portion 6, and an interface portion 8 which acquires the first image data stored in the first storage portion 4 and the second image data stored in the second storage portion 7 and outputs that data to an external location.

Referring to the image scanner shown in FIG. 1, an image from the manuscript P read-in at for example a resolution of 400 dpi (dot/inch) by CCD 1a is converted into digital multivalued image data of for example 24-bit color or 8-bit black-and-white by the A/D conversion portion 1b and is transferred to the black-and-white conversion portion 2 via a switching portion S. At the black-and-white conversion portion 2, if the multivalued image data transferred from the A/D conversion portion is color multivalue image data, the multivalue image data is converted into black-and-white multivalue image data and conveyed to the binarization processing portion 3 and the resolution conversion portion 5. If the image data conveyed from the A/D conversion portion is black-and-white, the switching portion is switched to operate with the connection opposite to that S shown in FIG. 1 and to bypass the black-and-white conversion portion 2 and to convey the black-and-white image data to the binarization processing portion 3 and to the resolution conversion portion 5. Black-and-white multivalue image data conveyed to the binarization processing portion 3 is made into binary data (1-bit) and is stored in the first storage portion 4 as the stored first image data. The switching means S initiates switches as necessary. For example, the switching portion S is adapted to switch in response to a signal from a programmed computer, for example, PC.

The color multivalue image data conveyed to the resolution conversion portion 5 or black-and-white multivalue image data conveyed to the resolution conversion portion 5 is converted to a lower resolution. Thus, the 400 dpi image data read-in by CCD 1a would be converted to a resolution lowered by an n th power of ½ wherei “n” is an integer, so that for example it would be converted to a resolution of 100 dpi, that is (½)² of the read-in data resolution. Further, in the multivalue processing portion 6 the gradation value of the image data is converted from for example 8 bits to 4 bits and the data is stored as the second image data in the second storage portion 7.

The first image data stored in the first storage portion 4 and the second image data stored in the second storage portion 7 are output to a personal computer (PC) 9 connected via the interface portion 8. The output from the interface portion 8 to the PC 9 of the first image data and the second image data is made alternately by line of data read-in or by page of data read-in. (Namely the first image data and the second image data are output alternately and line by line or page by page.) For alternate output of the first image data and the second image data page by page, memory is required for storing or holding image data read-in for two pages (front and rear pages) and for output of image data read in for two pages (front and rear pages). When the former alternate method is compared to the latter alternate method, the latter alternate method enables a reduction of in the necessary amount of memory.

When performing the alternate outputting of images line by line, it is necessary to take into account that the number of lines differs for each of two different sets of image data of different resolutions. For example, for an image with binary 400 dpi and multivalue 200 dpi a combination of 2 lines for binary and 1 line for multivalue must be allowed for, and for an image with binary 400 dpi and multivalue 100 dpi a combination of 4 lines for binary and 1 line for multivalue must be allowed for. On the other hand, when performing the alternate outputting of images page by page, alternate output of binary page image and multivalue page image is sufficient. In other words, even when there is image data of differing resolutions like the first image data (of binary image data) and the second image data (of multivalue image data) each can be output as an independent image, eliminating the need to handle different resolutions and thereby simplifying the output process.

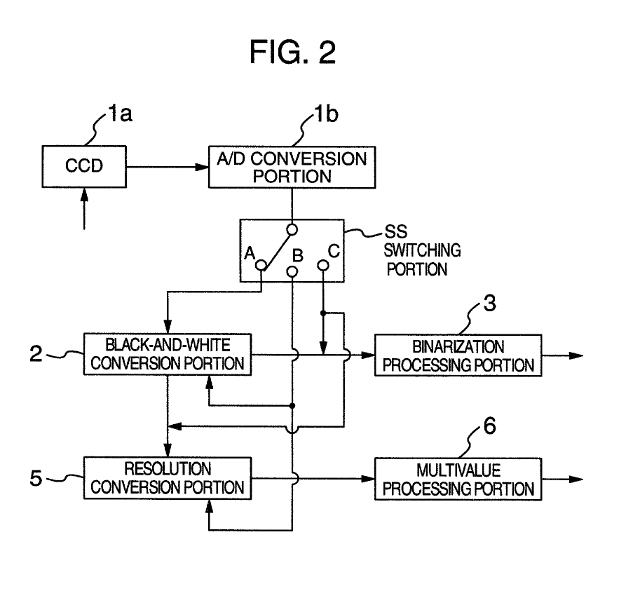

FIG. 2 is a partial block diagram showing a modified connection circuit having another example of switching portion S used in FIG. 1 arrangement, which connection circuit is used to substitute for corresponding portions shown in FIG. 1 and to operate with the other portions shown in FIG. 1. In FIG. 2 a modified switching portion SS having operation mode contacts A, B and C are provided to select an optional one of the three contacts such that each of the contacts A and B is selected for color data from CCD 1a, as mentioned below, and the contact C is selected for black-and-white data from CCD 1a. In the case of the switching portion operatively connecting with the contact C, the subsequent operations (or data flows) of the arrangement are effected substantially identical with those shown in FIG. 1 arrangement (having the switching portion S operating with the contact connection opposite to that shown in FIG. 1).

In FIG. 2, when CCD 1a reads in multivalue color image data such as mentioned with FIG. 1, and when the modified switch portion SS is operated to connect with contact A, the read-in data is converted through the conversion portions 1b and 2 to be conveyed to the resolution conversion portion 5. At the portion 2, the color multivalue image data is converted into black-and-white multivalue image data and conveyed to the portion 3, by which the conveyed data is made into binary data to be stored in the first storage portion 4.

The resolution of the black-and-white multivalue data conveyed to the resolution conversion portion 5 is lowered thereat with a reduction of data amount, and a resultant resolution converted data is transferred to the multivalue processing portion 6. At the portion 6, the converted data undergoes multivalue processings such as gamma correction, and a resultant processed data is transferred to and temporarily stored in the second storage portion 7. Interface portion 8 controls the first and second storage portions 7 and 8 in order to read out therefrom and transmit stored black-and-white binary data and multivalue black-and-white multivalue data alternately to PC 9.

Having the modified switching portion SS switched to make another connection (contact B), color multivalue data from the A/D conversion portion 1b is transferred to black-and-white conversion portion 2 and to resolution conversion portion 5. The color multivalue data is converted into black-and-white multivalue data to undergo binarization processing of the processing portion 3. Resultant processed data is temporarily stored in first storage portion 4. The resolution of the color multivalue data transferred to resolution conversion portion 5 is lowered thereat with a reduction of data amount, and a resultant resolution converted data undergoes multivalue processings of the processing portion 6. A resultant processed data is temporarily stored in the second storage portion 7. The binary data and color multivalue data stored in the first and second storage portions, respectively, are alternately output to PC 9 via interface portion.

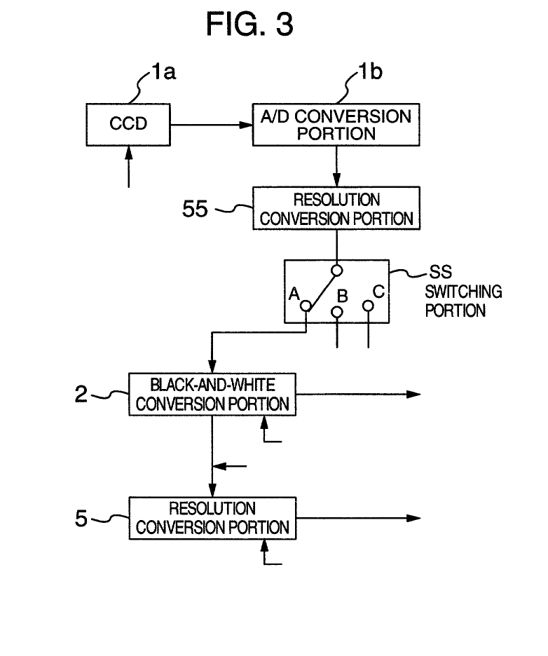

FIG. 3 is a partial block diagram showing a connection of additional resolution conversion portion to be incorporated into FIG. 1 arrangement modified with the modified circuit shown in FIG. 2. The additional resolution conversion portion is incorporated for lowering the resolution of binary or multivalue image data from A/D conversion portion 1b. By the addition, the resolution of multivalue image data from A/D conversion portion 16 can be further lowered by using the two resolution conversion portions.

As apparent from the above description with FIG. 1, the first image data thus output is high-resolution binary image data and the second image data thus output is low-resolution multivalue image data. In other words both high-resolution binary image data and low-resolution multivalue image data are obtained from the original multivalue image data read-in. Further, where the original image data read-in is color multivalue image data both high-resolution black-and-white binary image data and either low-resolution color multivalue or low-resolution black-and-white multivalue image data are obtained from that original data.

Accordingly, with an image scanner of the above-mentioned constitution, multivalue image data read-in by CCD 1a and processed by A/D conversion portion 1b is output as a combination of high-resolution binary data and low-resolution multivalue data the volume of which data is smaller than that of the high-resolution multivalue data originally read-in, hence preventing deterioration in transmission speed and reducing the processing load for other devices to which that data is transmitted.

When assuming an example such that multivalue image data read-in by CCD 1a and processed by A/D conversion portion 1b has a resolution of 400 dpi and a gradation value of 8 bits, where the volume of data at A4 size would be 124 megabits; if the first image data has a resolution of 400 dpi and a gradation value of 1 bit and the second image data has a resolution of 100 dpi and a gradation value of 4 bits, the corresponding data volume would be approximately 3.9 megabits and approximately 15.5 megabits, respectively. So the volume of data output from the interface portion 8 would be approximately one sixth (⅙) that of the 124 megabits.

As mentioned above, devices of the present invention output a combination of high-resolution binary data and low-resolution multivalue data the volume of which data is smaller than the volume of the high-resolution multivalue data originally read-in, hence preventing deterioration in transmission speed and reducing the processing load for other devices to which that data is transmitted.

What is claimed is:

1. An image input device comprising:
means for binarization for changing input black-and-white multivalue image data into binary data;
means for temporary storage of a first image data changed into binary data by the binarization means;
means for converting resolution for lowering a resolution of said multivalue image data;
means for temporary storage of a second image data with a resolution lowered by the resolution converting means; and
means for outputting said stored first image data and second image data.

2. An image input device according to claim 1, further comprising data conversion means for converting input color multivalue image data into black-and-white multivalue image data, wherein said binarization means is means for converting said black-and-white multivalue image data into black-and-white binary image data, and said resolution converting means is means for lowering the resolution of said black-and-white multivalue image data.

3. An image input device according to claim 1, further comprising data conversion means for converting input color multivalue image data into black-and-white multivalue image data, wherein said binarization means is means for converting said black-and-white multivalue image data into black-and-white binary image data, and said resolution converting means is means for lowering the resolution of said color multivalue image data.

4. An image input device according to claim 1, wherein said resolution converting means is means for converting the resolution of said multivalue image data to a resolution lowered by an n th power of ½ with an integer “n”.

5. An image input device according to claim 2, wherein said resolution converting means is means for converting the resolution of said multivalue image data to a resolution lowered by an n th power of ½ with an integer “n”.

6. An image input device according to claim 4, wherein said outputting means outputs alternately said first image data and said second image data line by line or page by page.

7. An image input device according to claim 5, wherein said outputting means outputs alternately said first image data and said second image data line by line or page by page.
